(19) United States
(12) Patent Application Publication
(10) Pub. No.: US 2022/0335354 A1
(43) Pub. Date: Oct. 20, 2022

(54) INTEGRATING AND AUTOMATING SUPPLY AND DEMAND CHAINS

(71) Applicant: REFASHIOND OS Inc., Yorktown Heights, NY (US)

(72) Inventors: Lisa MORALES, Yorktown Heights, NY (US); Jeffrey Lee KING, Dallas, TX (US)

(21) Appl. No.: 17/659,592

(22) Filed: Apr. 18, 2022

Related U.S. Application Data
(60) Provisional application No. 63/176,265, filed on Apr. 17, 2021.

(51) Int. Cl. G06Q 10/06; G06Q 10/08; G06Q 50/04; G06N 20/00

(52) U.S. Cl. CPC G06Q 10/06315; G06Q 10/083; G06Q 50/04; G06N 20/00

(57) ABSTRACT

An operating system environment (200) and network are provided for a supply and demand chain of an industry such as the fashion industry. The environment (200) includes an operating system (206) for integrating the operation of digital technologies 204 and enhancing the functionality of the digital technologies (204), for example, by facilitating access to shared resources (208). A user (202) may access the operating system (206) to initiate a digital technology integration process or to access digital technologies (204) of third parties. The operating system (206) may provide an API to facilitate communications, perform integration operations such as adjusting settings and certain code to facilitate interoperation of the technologies or interoperation of either or both of the technologies with resources such as databases. The operating system can be used to deploy a network of factories to implement local, small batch, just-in-time, replenishment, or post-purchase production and direct-to-consumer distribution.

### CROSS-REFERENCE TO RELATED APPLICATION

This application claims benefit of U.S. Provisional Patent Application No. 63/176,265, entitled, “OPERATING SYSTEM AND NEW BUSINESS METHODS FOR CONNECTING VALUE CHAINS AND ENABLING THE SHIFT FROM GLOBAL SUPPLY CHAINS TO DIGITIZED SUPPLY AND DEMAND CHAINS”, filed Apr. 17, 2021, which is hereby incorporated by reference in its entirety.

### FIELD OF THE INVENTION

The present invention generally relates to integrating and automating supply and demand chains. In particular, the invention relates to facilitating adoption and integration of digital technologies, and other products and services within a supply and demand chain, enabling localized, small-batch production responsive to short-term demand, and enabling novel marketplace implementations that reduce capital commitment time frames in connection with supply and demand chains. Particular implementations are described in relation to the fashion industry.

### BACKGROUND OF THE INVENTION

In many industries, supply chains are disconnected from short-term demand due to development and distribution time lags. For example, a company may have an idea for a new or improved product. The idea may then proceed through a process of market research, development and testing, and finally production and distribution. This process may take months or even years. In many cases, it is not known with certainty whether there is a public demand for the product, or what level of demand, until the product is available in the marketplace. As a result, there may be frustration due to underproduction or substantial waste due to overproduction, and there may be substantial time frames of capital commitment that restrain other economic activity, in a word, inefficiencies.

The fashion industry is illustrative. A product cycle may be initiated by a fashion designer who has an idea for a new product such as shoes, clothing, accessories, or other fashion products (“garments”). Fashion designers may be their own brands and/or they can work for a brand. In either case, most designers and brands work with numerous parties across their product sourcing, design, development, sampling, and manufacturing supply chain. For example, a designer or brand may work with a garment supplier to develop product samples for fashion shows or other market testing. In most cases, the garment supplier/manufacturer is not owned by the brand. The process for developing product samples may involve fibers/fabric selection, color and pattern development, and custom manufacturing. If market testing of prototype garments is successful, market forecasting and production may ensue. To that end, brands may work with textile factories, mills, sample makers, and factories to set up production for garments and ensure that production meets brand specifications.

Typically, in the current fashion industry environment, these factories are far offshore from primary markets for the garments. Because demand for particular garments may be transient and seasonal, brands generally ramp-up production significantly in advance of marketing to account for shipping channel delays and potential disruptions, and often order in somewhat inflated volumes, in relation to forecast demand, to ensure that sufficient supply is available in a timely manner in all geographical markets and to keep the item landed cost of goods sold low based on volume pricing.

This process results in difficulties and inefficiencies. It is not unusual in the fashion industry to have 30-40% overproduction from long-term forecasting. Such excess supply may result in reduced margins due to waste or discounting and large environmental impacts due to both overproduction and waste. This model is also susceptible to shipping costs, which are increasingly volatile, and supply chain disruptions. Moreover, because different entities in the supply chain (e.g., designers, material sources, brands, factories, shipping, etc.) typically have separate control systems, individual entities have limited visibility into the development and distribution workflow resulting in frustration and inefficiencies. This process also results in long-term commitment of capital as production begins well in advance of revenue flow from sale of the garments. There is also significant risk as commitments for production and volume are often made before demand is certain. There may also be macroeconomic impacts as conventional processes are labor-intensive, resulting in workflow execution in far offshore facilities with low labor costs. This creates trade imbalances and loss of opportunities for development in certain markets.

Some efforts have been made towards reshoring elements of the fashion industry. These often revolve around reducing labor costs by use of digital technologies such as digitally controlled equipment (software implement design tools, direct to fabric printing equipment, automated cutting and assembly equipment, etc.), software and hardware systems for efficient workflow management, e-commerce platforms, and other systems and software for automating, optimizing, and managing elements of the fashion industry supply chain. However, these digital technologies are emerging and evolving so quickly that chain participants are often unable to discover potentially useful technologies in a timely manner or to integrate independent technologies into a unified system. In many cases, these technologies may also involve significant initial capital investment, which is a substantial barrier to entry given the uncertain business model and competition from low-cost labor markets. In particular, these uncertainties are an obstacle to obtaining financing for small facilities that might be able to efficiently and nimbly service small and medium-sized fashion entities such as brands and retail outlets. As a result, reshoring has achieved only limited success in this industry.

### SUMMARY OF THE INVENTION

The present invention is directed to systems and associated functionality for integrating and automating supply and demand chains. It is useful in the context of various industries including the fashion industry. The invention improves the discovery and adoption of digital technologies, and other products and services, for improved supply and demand chain efficiency. In addition, the invention facilitates integration of such resources into a unified system. The invention also facilitates the launching and operation of microfactories close to consumers which, in turn, can improve local economies and macroeconomics. By improving the efficiency of supply and demand chains, the invention also reduces wastes, improves margins, and provides substantial benefits for the environment.

In accordance with one aspect of the present invention, a system and associated functionality (“utility”) are provided for assisting users in discovering resources for use in a supply and demand chain, for example, in the fashion industry. The utility involves establishing a knowledge base of resources for supply and demand chains of one or more industries by compiling a list of such resources and, for each resource, associating metadata with the resource defining attributes of the resource. The resources may include, for example, digital technologies, other products, and services/service providers. For example, in the case of the fashion industry, the digital technologies may relate to some or all of textile material science tools (e.g., fiber analysis/selection tools, chemistry tools, fiber design and physics simulation, etc.), fashion design tools (e.g., CAD tools, 3D modeling and Digital Twin tools, etc.), garment production tools (e.g., a chain operating system as described herein, product lifecycle management tools, factory workflow management tools, cut and print tools, assembly tools, etc.), and e-commerce tools (e.g., marketplace platforms, payment processing, order fulfillment tools, etc.). Other products may include base materials (e.g., raw materials, fibers, etc.), processed materials (e.g., yarns, fabrics, etc.), supplies (e.g., dies, chemicals, buttons, etc.), creative properties (e.g., designs, patterns, artwork, etc.) and the like. Services/service providers may include designers/design firms, manufacturers, distributors, influencers, materials consultants, financing sources, etc. The metadata may, for example, associate the resources with resource categories, identify credentials and skills of service providers, identify particular features of the technologies, identify complementary technologies, identify a source country or region for service providers or materials, identify certifications (e.g., relating to environmentally friendly, sustainable, or fair-trade practices), include compatibility information or specifications, and the like.

The utility further involves receiving a user input concerning one or more subject resources, determining from the input one or more attributes of the subject resources, and comparing the attributes of the subject resources to the knowledge base to identify matching resources. For example, users may submit queries concerning their supply and demand chain environments or needs, answer a survey concerning current resources used, select predefined user interface elements (e.g., from a pull-down menu or icons) or otherwise provide information reflecting their interests. Those inputs may be used to identify attributes of resources that may be of interest and to match those attributes to attributes of resources of the knowledge base. The attributes may be inferred from textual/context analysis, obtained from the structure of a survey template, or determined by advanced processing such as artificial intelligence/machine learning or sequential decision analytics. The matching may involve identical attribute values, similar attribute values, complementary attribute values, or values/characteristics that are otherwise deemed to tend to commend the associated resources for inclusion in a response.

In one implementation, the resources included in the knowledge base have been curated and selectively integrated into supply and demand chain network. For example, such resources may be integrated into the network based on an application by an interested party followed by vetting by network administrators. In the application, the interested parties may be required to provide information concerning credentials, experience, accomplishments, specifications of materials, information concerning sourcing of materials, certifications, production capacities, technology features, etc. The network administrators can then verify credentials and certifications, test products, confirm sourcing information, and otherwise vet the resources prior to including them in the knowledge base. Accordingly, users of the discovery tool will be assured that the resources identified are appropriate and trustworthy and the information concerning the resources is accurate.

The utility further involves providing an output concerning the matching resources. Thus, the inventive system may identify a digital technology or technologies (e.g., a set of technologies that are integrated to cooperatively work toward a supply and demand chain function or “techstack”) for potential adoption by the user and/or provide a list of potential technologies with descriptions or links to resources. In the case of other products or services, the output may include, for example, information identifying sources of the goods or services, information describing the goods or services, or links to purchase or access the goods or services. It will be appreciated that the invention thus assists users in discovering appropriate resources to encourage and accelerate adoption and facilitate networking between participants in the network.

In accordance with another aspect of the present invention, an operating system is provided for a supply and demand chain, i.e., for managing resources of the chain. An associated utility involves providing a supply and demand chain operating system and providing at least first and second resources for integrated operation in the chain. For example, the operating system is operative to manage multiple digital technologies, for example, technologies that are vertically or horizontally integrated in the chain, or other products or services/service providers. Again, in the case of the fashion industry, the digital technologies may include some or all of textile material science tools, fashion design and management tools, garment production and management tools, e-commerce tools and others. The tools may be managed to work together to accomplish a function or to work sequentially in executing functions of the chain. The first and second resources for integration may be provided or operated by different parties in a supply and demand chain, for example, in the case of a fashion industry implementation, a designer/brand and the factory or a factory and a retail outlet or shipper or all of these parties. In the case of other products or services, the operating system may facilitate, organize, and otherwise manage collaboration and production processes. For example, a brand may access the operating system to use design services of a participating designer to develop a design and then use an application, via the operating system, to generate a three-dimensional digital model of a resulting garment design for marketing purposes. In that case, the operating system may be used to coordinate communications between the brand and the designer, to track progress of the project, and to execute payments based on completion of the project or milestones defined by a smart contract.

The utility further involves employing the operating system to perform integration functions to facilitate integration of the first and second resources. For example, the functions may include at least one of 1) a communications function for facilitating communications between the first and second resources, 2) a shared resource function for enabling the first and second digital technologies to access one or more shared resources, 3) a collaboration resource for facilitating collaborative development of a workflow operation(s) using the first and second digital technologies, and 4) a tracking function for tracking progress of a project or movement of a product or component. The communications function may include providing an API that establishes formats, protocols, fields, and values, and/or application-to-application communications. The shared resource function may involve accessing software tools or databases for use by the first and second technologies or providing a dashboard of workflow status/progress and financials. In the case of the fashion industry, this may relate to production techpacks, equipment settings and parameters, defined patterns and color information, and the like. Collaboration resources may include collaborative design tools, parameters for interoperability of equipment, and the like. All of these functions may be cloud-based or may involve calling localized data into a cloud-based platform to enable real-time throughput, capacity, and load sharing across parties.

The tracking function may include tracking progress of a project through a multi-process workflow including noting milestones in the workflow or tracking the provenance of a material or distribution of a completed product. In this regard, in some cases, the operating system can be used to track a project from the sourcing of raw materials, through design, production, and delivery, for example, to verify sourcing, fair-trade and environmentally friendly processes, or that other standards or specifications are satisfied. Such tracking may also involve monitoring each facility, group or person who worked on a product. In this manner, quality can be monitored at each level of the process and any training needs or maintenance issues can be identified and corrected. A ratings system may also be implemented, e.g., a peer rating system, to encourage high standards and help participants identify preferred providers in the network. The operating system can thereby reduce or substantially eliminate integration efforts between participants or technologies and promote interoperability of digital technologies in the chain.

The workflows that are managed by the operating system can vary depending on the participant and project. As noted above, the operating system may be involved in a project from sourcing of raw materials through sale and fulfillment of final products. In the case of the fashion industry, this may involve managing a project from sourcing of fibers, through fiber production, yarn production, fabric production, fabric finishing, marketing garments, receiving purchase orders from an e-commerce platform, placing production orders for garment production, garment production, delivery, processing returns and recycling/re-using materials. However, other participants may use the operating system for more limited purposes and the associated workflow may be correspondingly limited in scope. For example, a fabric design provider may use the discovery tool of the network noted above to find a particular fabric material that meets the needs of fabric designer's external (to the network) client and then engage a fabric printer (e.g., provided by the network operator or a participant) to simply print its fabric design onto the selected fabric. In that case, the workflow may only encompass provision of the fabric material through printing or just printing. Thus, any portion of a process between sourcing of raw materials through delivery of final products may constitute a workflow within the network or managed by the operating system.

In accordance with the still further aspect of the present invention, a utility is provided for efficient implementation of distributed production facilities, e.g., microfactories for localized manufacturing. The utility involves establishing first and second production facilities (e.g., textile factories), where each facility has at least one piece of digitally controlled equipment (e.g., a direct to fabric printer, a digital cutting machine, or a digital sewing/assembly machine) and a standardized techstack. The techstack includes at least a digital technology for controlling the digitally controlled equipment and an interface for accessing operating information from a central facility. The utility further involves using the techstack of each of the facilities to access order information for producing products (e.g., garments) pursuant to an order and parameter information concerning parameters for operating the digitally controlled equipment to produce the products. For example, in the case of the fashion industry, multiple textile factories may receive instructions from a central facility to produce specified numbers of a given garment based on local demand. The factories may further receive techpacks for the garment and specific operating parameters for a direct to fabric printer, digital cutting machines, and the like. The facilities can then be operated to fulfill at least a part of the order. Multiple factories can thereby be efficiently deployed to satisfy local demand in short time frames, thus promoting local employment and reducing the time frames of capital commitment.

In accordance with another aspect of the present invention, the value of various functions in a supply and demand chain are tokenized for enhanced efficiency. An associated utility involves providing a platform for facilitating and managing industry workflows including workflows of one or more supply and demand chain functions. For example, in the fashion industry, the functions may include textile selection, fashion design, garment production, and e-commerce services for garment sales and distribution. The utility further involves defining credits for valuing chain assets and functions and establishing a marketplace for buying and using the credits. The marketplace can receive, from a first authorized workflow participant, a request for credits and value for purchase of a specified quantity of credits. In response, the marketplace can apply the credits to an account of the first authorized workflow participant. The platform can then communicate, between the first workflow participant and a second or multiple workflow participants, a request for goods or services from the first workflow participant and an acceptance from the second or multiple workflow participants. For example, in the case of the fashion industry, a brand may request production of a certain number of garments and a factory network may accept the request. In connection with the resulting transaction, the platform may debit, from an account of the first workflow participant, a first credit value associated with the project and credit, to an account of the second or multiple workflow participants, a credit value associated with the project. The credit system may be centrally managed or managed through a decentralized structure such as a Decentralized Autonomous Organization.

Periodically, the marketplace may be accessed by workflow participants to convert credits to external value. For example, credits may be converted into currency values that can be transferred to a designated account of a financial institution or credits may be converted to tokenized currency, for example, a crypto currency that requires conversion to FIAT. The credits may be incorporated into a blockchain structure to provide transparency of costs throughout the workflow, for example, in the fashion industry, potentially extending from fiber sourcing to finished goods. It will be appreciated that this credit system facilitates transactions as well as the deployment of smart contracts and associated tracking which improve visibility of the status of the workflow for all participants. Moreover, this credit system enables new options for implementing transactions, especially for small and medium-size companies. For example, in NFTs of fiber lots may be fractionally sold for conversion to thread or yarn and released as needed via smart contracts. In this manner, such companies may have access to fiber lots that may previously have been unavailable to low volume purchasers, thereby significantly democratizing the industry. In addition, the credits model frees up working capital as commitments can be short, e.g., monthly allocations of capital of credits being converted to “just in time” production credits that can be replenished as needed. At the end of the month, brands or other participants are not holding excess raw materials or inventory that, in conventional fashion industry supply chains, may get marked down (thus reducing overall margins) or that goes to landfill or incineration.

### BRIEF DESCRIPTION OF THE DRAWINGS

For a more complete understanding of the present invention and further advantages thereof, reference is now made to the following detailed description, taken in conjunction with the drawings, in which:

FIG. 1 is a schematic diagram of a resource discovery system for a supply and demand chain in accordance with the present invention;

FIG. 2 is a schematic diagram of an operating system environment of a supply and demand chain in accordance with the present invention;

FIG. 3 is a schematic diagram of a microfactory network of a supply and demand chain in accordance with the present invention;

FIG. 4 is a schematic diagram of a credit-based marketplace of a supply and demand chain in accordance with the present invention;

FIG. 5 is a schematic diagram of a fashion industry supply and demand chain in accordance with the present invention;

FIG. 6 includes block diagrams showing various considerations related to credits and digital objects of a supply and demand chain in accordance with the present invention;

FIG. 7 shows elements of a supply and demand chain in accordance with the present invention;

FIG. 8 is a schematic diagram showing elements of a supply and demand chain in accordance with the present invention;

FIG. 9 is a schematic diagram of a microfactory in accordance with the present invention;

FIG. 10 is a schematic diagram of a pod or circular module of the microfactory of FIG. 9.

### DETAILED DESCRIPTION

The present invention is directed to various systems and functionality for integrating and automating supply and demand chains. In the following description, the invention is set forth in the context of various examples relating to the fashion industry which is believed to represent a particularly advantageous implementation of the invention. However, it will be appreciated that the various aspects of the invention are not limited to this industry or context. Accordingly, the following description should be understood as exemplary and not by way of limitation.

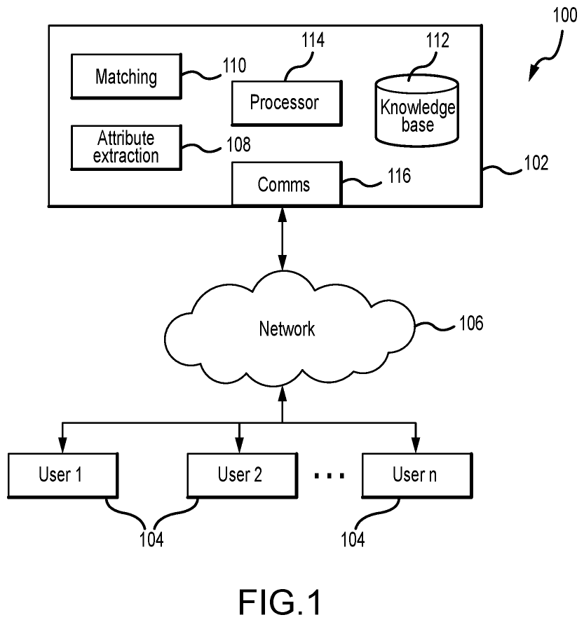

FIG. 1 shows a resource discovery system 100 in accordance with the present invention. As noted above, digital technologies, as well as other products and services, for various functions in supply and demand chains are rapidly emerging and evolving in many industries. As a result, it is difficult for participants in such supply and demand chains to keep abreast of what resources are available and what systems or production specifications they are compatible with. The illustrated system 100 enables users 104, such as supply and demand chain participants, to access a discovery platform 102 via a network 106 such as the Internet. The illustrated platform 102 includes an attribute extraction module 108, an attribute matching engine 110 and a knowledge base 112. Communications between the platform 102 and the systems of users 104 are managed by a communications module 116 which may implement an API and manage messaging protocols, formats, fields and values, and other communications parameters. The functionality of the platform 102 is executed on a processor 114. Although the platform 102 is schematically illustrated as a single system, it will be appreciated that the functionality of the platform may be distributed across multiple machines (e.g., servers, computers, or other processors) at a single location or geographically distributed with cloud-based infrastructure. The various functional elements of the platform 102 may be implemented in software, hardware, and/or firmware executed by the processor 114.

The knowledge base 112, which may be implemented in one or more database systems, includes a list of resources available for one or more supply and demand chains as well as attributes of the various resources. As noted above, supported digital technologies may include digitally controlled equipment (e.g., digital direct to fabric printers, digitally controlled cutting machines, digitally controlled sewing machines, etc.), software (e.g., design tools, pattern libraries, workflow management tools, etc.), and platforms (e.g., e-commerce platforms, order fulfillment platforms, etc.) among others. Other products or services may include base materials, processed materials, supplies, creative properties, designers, manufacturers, distributors, financing sources, etc. The information included in the knowledge base 112 may vary depending on the technology but may include, for example, in the case of digital technologies, compatible files, compatible systems, dimensions, types of fabrics, settings, and the like. In the case of other products and services, the information in the knowledge base may include credentials, certifications, experience, skills, and the like. The various resources may be indexed in relation to such attributes and attribute values to facilitate searching.

The attribute extraction module 108 is operative to receive and extract attributes from the input information for use by the matching engine 110. In operation, a user 104 may access the platform 102 to initiate a search or request for information concerning resources of interest. Such an input may be a free-form search request, or a user may be guided through a survey or other structured search process. For example, a user may be prompted to enter various information concerning digital technologies or services of interest. This may include information identifying the industry of interest, identifying the user's or targeted service provider's position or role in the supply and demand chain (e.g., in the case of the fashion industry, whether the user is a designer, a brand, a manufacturer, a distributor, etc.), what function the user is interested in (e.g., accessing design services, accessing design libraries, downloading design files for digital equipment, or accessing fiber analysis/selection tools), and/or entering information about digital technologies/equipment currently being used by the user. The module 108 extracts attributes from this input information and associates the metadata with attributes describing the data. For example, an apparel factory user may wish to discover compatible libraries of garment information for producing garments. The platform 102 may present survey questions in the form of a template or allow the user to identify relevant subject matter by clicking on icons or making selections from a pulldown screen among other options. The platform may return recommendations based on survey results or other user inputs that provide the top relevant apps, software, and/or systems compatible with, for example, the direct to fabric digital printer. For example, based on the user inputs, the module 108 may extract search attributes identifying the direct to fabric printing function and identifying a type of fabric. Based on, for example, the structure of the template or textual/context analysis, the module 108 may associate metadata with each of these attributes identifying the nature of the attribute (e.g., “garment production operation” or “fabric type.” It will be appreciated that many other examples of attributes and metadata may be employed. This discovery process is distinct from the operating system processes, described below, involving dissemination of techpacks and calibration factors for production of garments.

The matching engine 110 is operative to match the user inputs to relevant resources from the knowledge base 112. In this regard, a variety of matching algorithms or logic may be implemented to execute such matching. A simple implementation involves matching the attributes from the extraction module 108 to attributes of particular resources of the knowledge base 112. In this regard, for example, all resources having matching attributes may be identified, multiple matching attributes may be required, or resources may be scored based on numbers of matches and materiality of matches. Moreover, the matching process may be limited to exact matches or may include near matches such as closely related attribute values or matches to related attributes. More complex logic may involve processing multiple or all of the attributes of the user input to derive a pattern or signature that can be matched to corresponding signatures for resources of the knowledge base 112. Still more complex matching logic may involve using artificial intelligence or machine logic to learn how to match user inputs to particular resources of the knowledge base 112.

The platform 102 may generate a response for transmission to the requesting user 104 depending on the results of the matching process. The nature of the response will depend, for example, on the nature of the request. In this regard, the response may be an app store interface where the user 104 is presented with digital technologies, or stacks of integrated digital technologies, that are deemed responsive to the request and/or displayed as the latest recommendations upon login or may include information identifying other products or services. For example, a textile factory user interested in print libraries may receive a list of print libraries that are available for purchase or subscription. Digital technologies identified in the response may be ordered based on relevance, ease of integration, compatibility with other digital technologies that are part of an industry supply and demand chain operating system, based on which vendors have paid to be prioritized, or other bases. Additionally or alternatively, the user may receive information regarding matching digital technologies and/or complementary digital technologies. Such information may include sales literature, specifications, compatibility information, links to online demonstrations, testimonials, and the like. In still other cases, the platform 102 may provide information concerning techpacks, calibrations, settings, online forums, and other information related to digital technologies that the user is already using. Thus, the platform 102 can provide a variety of information to help users discover, purchase, and use available digital technologies and other product and services. With regard to discovery, user data may be employed to increase the ranking of apps, hardware, or other technologies, products, or services. For example, ratings and review information concerning usage, satisfaction, and the like, may be used for ranking purposes to thereby assist in discovery and selection of resources beyond just the metadata as discussed above. The platform may also include or link to an e-commerce platform for consummating transactions and processing payments. In addition, the platform 102 may be integrated with or linked to a supply and demand chain operating system as described below.

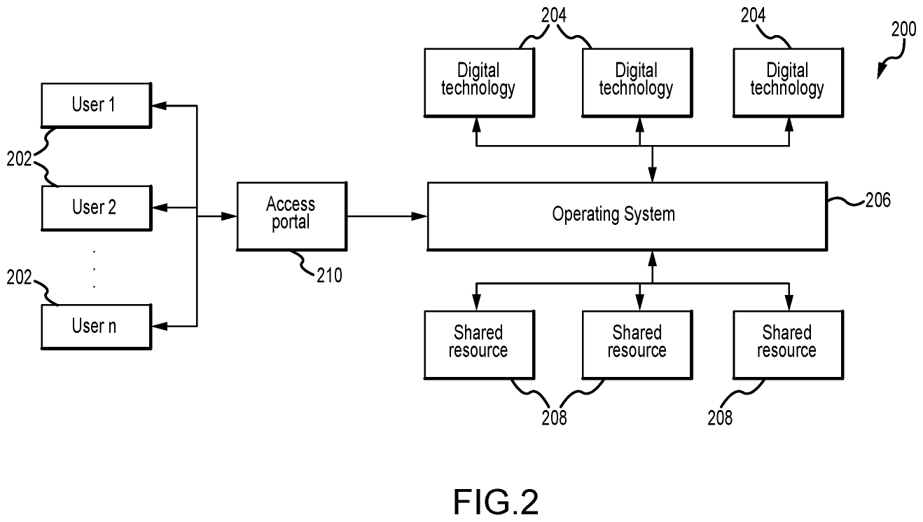

FIG. 2 is a block diagram illustrating an operating system environment 200 in accordance with the present invention. The environment 200 includes an operating system 206 for integrating and managing the operation of resources such as digital technologies 204 and enhancing the functionality of the resources, for example, by facilitating access to shared resources 208. The following description focuses on integrating digital technologies which provides particular benefits. However, it will be understood that the operating system environment is not limited to integration and is not limited to digital technologies but extends more generally to a range of management functions for digital technologies as well as other products and services. In operation, a user 202 may access the operating system 206 via an access portal 210. For example, the user may access the operating system 206 to initiate a digital technology integration process or to access digital technologies 204 of third parties, e.g., on a subscription basis. In this regard, when a user 202 purchases or subscribes to one or more digital technologies via the discovery tool as described above, the user may employ the operating system 206 to integrate the technologies or to integrate with third party or subscription technology. Such integration may relate to enabling communications between the technologies, enabling the digital technologies to access shared resources 208, and enabling the technologies to engage in collaborative development of a project, among other things. In this regard, the operating system may provide an API to facilitate communications, may perform integration operations such as adjusting settings and certain code to facilitate interoperation of the technologies or interoperation of either or both of the technologies with resources such as databases, and the like. The operating system 206 may be implemented as software or other logic resident on a cloud-based platform and may be implemented on one machine or multiple machines in a single location or geographically distributed. For example, the functionality of the operating system 206 may be distributed between a cloud-based platform and functional components resident on user devices and/or digital technology platforms.

In other cases, a user 202 may access the operating system 206 to facilitate operations between a digital technology of the user and third party or subscription digital technologies 204. For example, in the context of micro textile printing factories as described in more detail below, a central facility may transmit operating parameters to one or more pieces of digitally controlled equipment of the textile printing factory. The operating system 206 may be involved in this regard to facilitate communications between systems of the central facility and the digitally controlled equipment and may provide techpacks, calibrations, or other specifications and operating parameters for executing a project such as direct to fabric printing or digitally controlled cutting and sewing operations.

In this context, the shared resources 208 may include specific settings or operating parameters, for example, to optimize performance of a direct to fabric printing operation based on the type of machine, the type of fabric, the dies/inks and pattern involved, or other factors. In many cases, such information available in connection with use of the operating system 206 will be the best source for consistently and accurately replicating desired patterns, proper dimensions, or other results. Moreover, as the operating system 206 may process a large volume of operations for a particular industry, it is anticipated that the operating system 206 will develop a definitive resource for such knowledge, i.e., a knowledge base of one or more searchable databases, that can be made available as a shared resource 208. Other types of shared resources 208 may include adapters or sockets for interconnecting logic, a variety of software tools for enhancing the operation of equipment and other digital technologies 204, libraries of fiber blends, textiles, techpacks, and other resources, and the like.

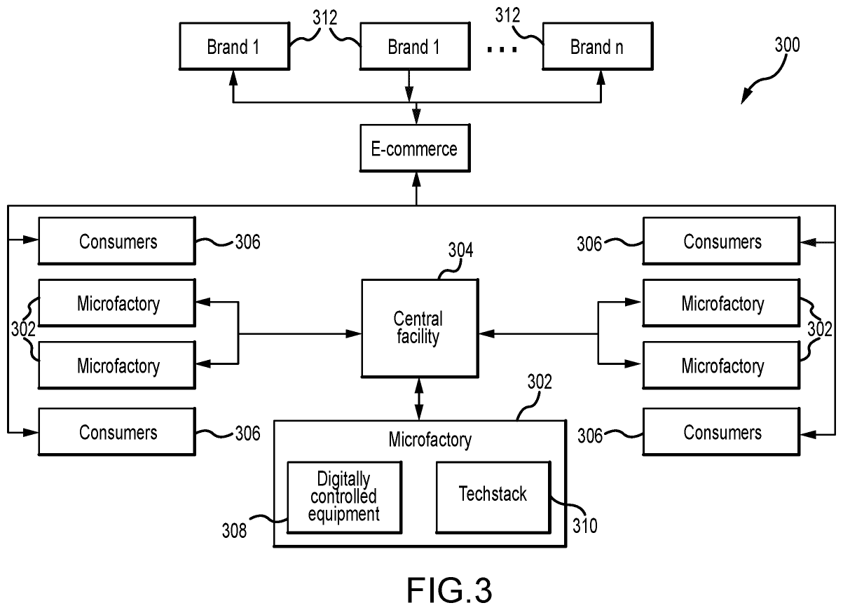

FIG. 3 illustrates a network 300 of standard dactories 302 and/or microfactories (one shown in detail) that execute orders in coordination with a central facility 304. Microfactories, as will be described in more detail below, are useful because they require as few as 35-70 skilled seamstresses or overall workers within a footprint of as small as 5 k sq ft. The smaller size enables these microfactories to be deployed in more densely populated regions where it would otherwise be cost prohibitive to deploy a 100 k sq ft facility and that would lack enough local skilled factory workforce. Microfactories could even be added within a retail shopping center, enabling consumer-facing co-creation experiences. However, the advantages of the network of factories are not limited to microfactories.

One of the objectives of the present invention is to enable or facilitate the operation of large-scale or factories 302 to implement small batch, just-in-time, or post purchase production processes close to consumers 306. This has many potential advantages. First, such factories 302 may be able to generate products quickly, in response to orders from consumers 306 based on each consumer's measurements, print designs, key structural elements, like necklines or sleeve length, and other variables. This reduces or substantially eliminates time frames where capital is committed to inventory that ends up being the wrong sizes, prints, and colorways; also known as dead stock. In addition, it can avoid problems of underproduction or overproduction thereby avoiding frustration and reducing waste which has advantages for the environment. Reducing waste also increases margins and enables local factories to compete with offshore facilities. The factory network 300 can therefore promote reshoring for certain industries and create local jobs.

The illustrated factories 302 include one or more pieces of digitally controlled equipment and a common techstack 310. In certain implementations, some or all of the factories 302 may have identical pieces of digitally controlled equipment 308 such that multiple factories 302 can be employed to fulfill an order for specific garments with consistent results. For example, in the case of the fashion industry, the digitally controlled equipment may include direct to fabric printing machines, cutting and sewing machines, assembly machines, finishing machines, knitting machines, and the like. The techstack 310 preferably includes at least communications software for facilitating communications between the factory 302 and the central facility 304 and a digital technology, for example, software, for controlling operation of the equipment 308. Although the techstack 310 is illustrated as being resident at the factory 302 the functionality of the techstack may be distributed between the factory 302 and the central facility 304 and/or other platforms.

In operation, brands or retailers 312 may advertise products such as garments on an e-commerce platform 314. The advertised products may be physical products (e.g., existing products or prototypes) or may be digitally rendered products. Consumers 306 may use the e-commerce platform 314 to place orders for products from the brands 312. These orders are then aggregated by the brands 312 to generate aggregated orders that are placed with the central facility 304. The central facility 304 may then place orders with the factories 302 for production of the products. In this regard, the orders may relate to unique products of individual brands 312 or, in some cases, orders of specific products may be aggregated as between brands 312 (with rebranding instructions as necessary). For example, the factories 302 may be located in different geographic regions and individual factories 302 may be employed to fulfill portions of an order associated with the corresponding geographic region. In this manner, delivery costs, energy consumed, and timelines can be reduced. Interoperation of the factories, the central facility, the e-commerce platform and the platforms of brands and consumers (or portions thereof) may be facilitated by the chain operating system as described herein.

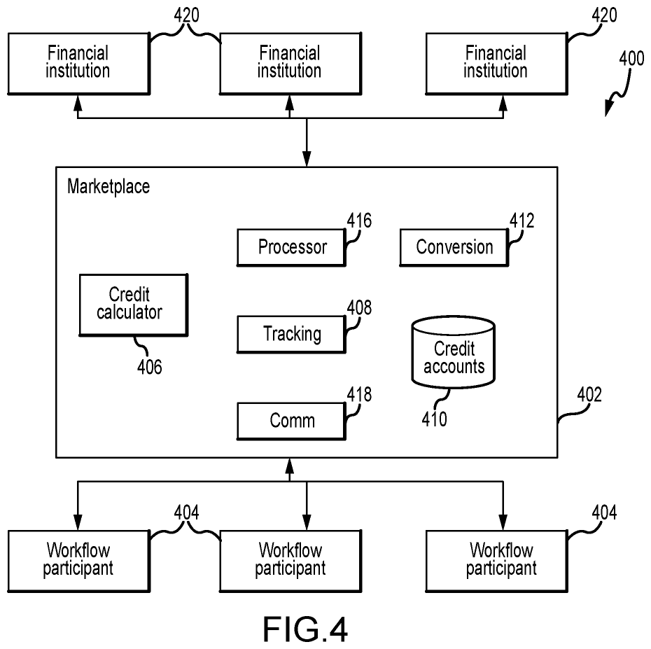

FIG. 4 is a block diagram of a marketplace environment 400 of a supply and demand chain in accordance with the present invention. The environment 400 may be implemented in the context of an operating system in accordance with the present invention. As noted above there are many advantages that can be achieved in the context of a supply and demand chain by defining functions in relation to credits that can be converted to FIAT currency or that have been assigned FIAT currency value. These advantages include reducing instances of accessing financial institutions and associated costs, leveraging functionality developed in connection with cryptocurrencies such as smart contracts, promoting greater certainty of values within an industry supply and demand chain, and reducing working capital commitment time frames with unrealized returns, among others. The illustrated environment 400 includes a credit-based marketplace 402 that can be accessed by workflow participants 404 to purchase and use credits as well as to convert credits into currency, e.g., converted to crypto currency or FIAT currency. In the case of the fashion industry, the workflow participants may include designers, brands, digital technology providers, factories, retailers, shippers, and others.

The marketplace 402 includes a credit calculator 406, a workflow tracking module 408, a credit accounts database 410, and a conversion module. Each of these elements may be implemented as software or other logic executed on a processor 416. Although illustrated as a single element, the processor 416 and marketplace 402 may be implemented on a single machine, multiple machines, or cloud computing deployed in a single location or geographically distributed.

The credit calculator 406 calculates credit values corresponding to particular supply and demand chain functions. As will be described below, multiple factors may go into determining credit values and these may be specific to a function and project. For example, the factors may include the function involved, the nature of the product, the complexity of the function based on the nature of the product, raw materials, the finish level, and others. As a participant 404 purchases and uses credits, credit balances for the participant may be tracked in the database 410. The operator of the marketplace 402 may receive remuneration for the marketplace services by direct fees, measured in credits or currency, by differences between credit purchase and credit conversion values, or other value by agreement of the participants and/or as permitted by applicable laws and regulations.

The tracking module 408 tracks progress of a project in the supply and demand chain. As noted above, conventional chains are typically executed across a series of discrete systems. As a result, it is often difficult to track the state of a project and individual participants may have limited visibility into the workflow. The tracking module 408 can monitor a supply and demand chain workflow or portions thereof and report the state to participants via a dashboard provided as part of the operating system as described above. The module 408 can track progress in a number of ways. First, in cases where the workflow is executed by digital technologies managed by an operating system as described herein, the operating system will be able to monitor execution of individual functions as part of the workflow. In other cases, the marketplace may receive reports from participant systems or may poll participant systems for status information. As a further alternative, the workflow may be implemented as one or more smart contracts where transfers of credits between parties are triggered by completion of functions or other milestones. Such smart contracts may be executed by the platform 402 and the resulting status information may be tracked by the module 408.

From time-to-time (e.g., periodically or on demand), participants may wish to convert credits to currency. In this regard, participants may purchase credits with crypto currency or FIAT currency for a standard currency value and may also convert credits to crypto currency or FIAT currency. For example, upon completion of an order and the resulting crediting of credits to participants 404, such as a microfactory, the participants may wish to convert all or a portion of their credit balance to currency. To do so, the participants may submit an appropriate instruction to the platform 402 causing credits to be debited from the participant's account. The conversion module 412 calculates a corresponding currency value and digitally transmits or wires that amount to an account of record of the participants at their financial institutions 420. A purchase by a consumer may trigger multiple releases of payments. For example, if a consumer purchases a product (e.g., a dress) of a particular designer, the purchase event may trigger the release of payments to all parties involved in the production of the purchased item, from the raw materials provider, to the factory producing the finished goods, to the delivery companies. Every party will see real time credit/FIAT currency payment as credits are used/redeemed. It will be appreciated that currency values may be provided to participants 404 in other ways such as by a mailed check.

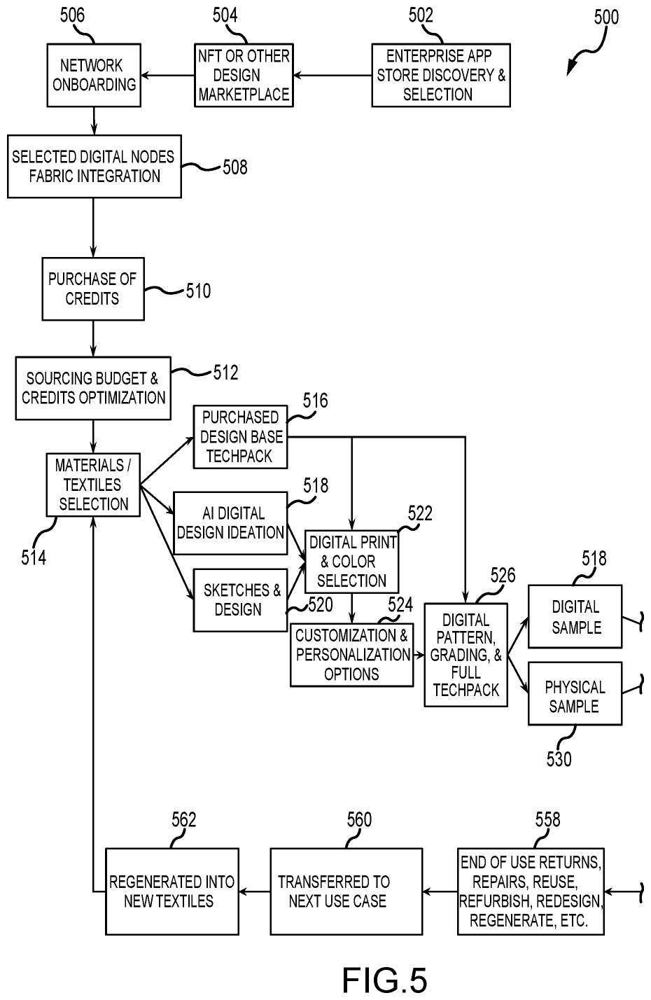

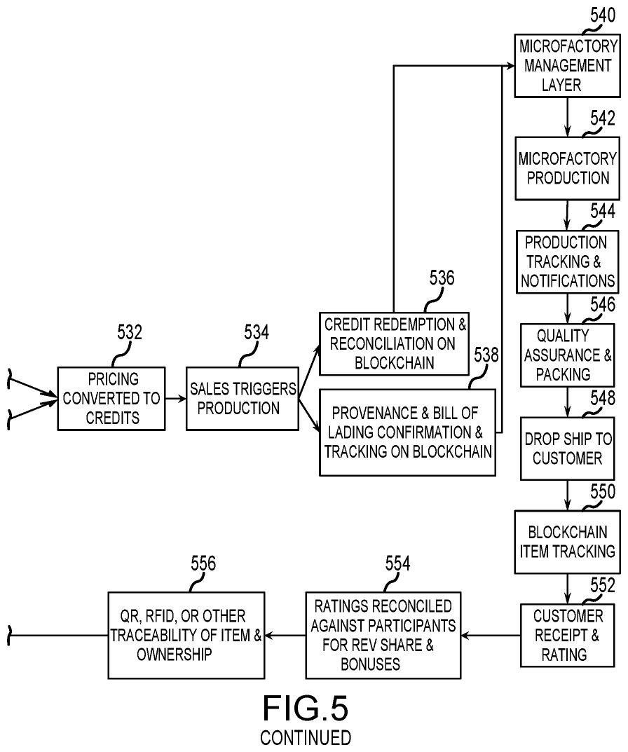

FIG. 5 illustrates an example of a supply and demand chain workflow 500 of the invention in the context of the fashion industry. The process 500 may be implemented in the context of an operating system environment. The illustrated workflow 500 is initiated by using a discovery platform, e.g., an enterprise app store 502, to discover and select one or more digital technologies for use by a workflow participant in the supply and demand chain. For example, the technology may be a design tool, an e-commerce tool, or a workflow management tool. In this case, a participant may acquire a workflow management tool specifically designed for the fashion industry and supported by the operating system described herein. Then, the participant may use the tool to access a digital design for a garment via a design marketplace 504. Designers may market their designs conventionally or via NFT's to control access and protect intellectual property embodied in the designs.

The digital design then passes through a network onboarding process 506 that may involve loading files, reformatting data, and other processing to ensure compatibility with digital technologies of the operating system. The next step of the illustrated workflow 500 involves operating system or framework integration 508. As part of the workflow design process, the participant may identify one or more third-party digital technologies for integration depending on the nature of the project or such technologies may otherwise be identified. The integration process may be fully or partially automated as part of the operating system. In any event, the integration process enables technologies accessed by participants to be integrated into a unified supply and demand chain system. Next, a participant may purchase 510 credits for use in consummating supply and demand chain transactions. As described in more detail below, the credit costs and related values of various supply and demand chain functions can be determined by an algorithm or other logic such that a participant can readily determine the amount of credits required for a project or transaction. Moreover, the operating system may provide, as a shared resource, a tool for optimizing 512 budget and credits. This may involve identifying optimal material and service providers, as well as processes, accounting for the full lifecycle of a project, including minimizing waste and reducing time frames of capital commitment.

For many fashion industry projects, the production process may continue with materials/textile selection 514. Depending on the nature of the project, this may involve selection of finished fabrics or selection of fibers, yarns, or other basic materials. The illustrated workflow 500 may branch at this point depending on the project and digital technologies employed. In some cases, the design phase of the project may be implemented using a design base techpack 516, e.g., a set of technical specifications or instructions for producing a specific product. The techpack may address, for example, the materials to be used, the fiber content, the pattern, the design, other quality specifications, and instructions for manufacturing the product. Such techpacks, which are provided in connection with conventional production processes, may be distinguished from calibration and setting information that may be provided as a shared resource of an operating system in accordance with the present invention. For example, the calibration information may provide detailed instructions on how to print on different materials using specific equipment. In this regard, various factors such as temperature, humidity, maintenance status of equipment, and the like may have an impact on printing or other functions. All of these parameters may be specified and monitored via the operating system, for example, to ensure consistent results when a project is distributed among multiple production facilities. In other cases, designers may use legacy or proprietary technologies for digital design ideation 518, e.g., including artificial intelligence tools for assisting in design ideation, sketches and design 520, digital print in color selection 522, and customization and personalization 524. The result of the design phase is typically digital 528 or physical 530 samples. Physical samples, of course, may be actual garments used for wholesale, shows, and other promotional/market testing efforts. Digital samples can be used for virtual try-ons, virtual shows, pre-orders, and the like.

The samples and associated marketing results in orders and demand. Within the supply and demand chain, pricing between participants may be converted 532 to credits. Sales, to brands or directly to consumers, trigger 534 production. Production transactions can be consummated either by credit redemptions 536 or via a digital or physical purchase order 538. In the case of credit redemption, the associated transfer of credits can be reconciled via a blockchain data structure. In the case of purchase orders, blockchains and smart contracts may be used for confirmation and tracking.

The workflow 500 may then proceed to the microfactory management layer 540. As discussed above, orders can be fulfilled via multiple microfactories, for example, having common digital equipment, licensed operating playbook, and techstacks, to provide responsive and local, post-purchase production 542. The playbook promotes consistency across all the collaborating entities in conjunction with the operating system. For example, if a given factory does not have the same standards for maintenance of the same digital printers with the same daily, weekly, monthly, quarterly, and annual maintenance, that factory could fail to provide standardized outcomes even using the standard techpacks and calibration information. A given order may be divided between microfactories on a geographic basis. Thus, product recipients (e.g., retail outlets or individual consumers) can be matched to individual microfactories based on geographical location. This may involve comparing an address/geocode of the recipient (e.g., determined using a GIS system) to addresses/locations of the microfactories or defined regions of the microfactories. Because these factories use the operating system, production can be tracked 544 and notifications of milestones and payments can be generated and reported via the dashboard, thus improving visibility of the workflow 500 and environmental impact to participants.

The workflow 500 continues with quality assurance, e.g., manual and/or automated inspections, and packing 546 followed by drop shipping 548 to customers, e.g., brands, retail outlets, or directly to consumers. Blockchains may be used for item tracking 550 and customer receipt and feedback or rating information 552 may be received via an online platform. The ratings 554 can be aggregated and reconciled against individual participants for revenue sharing and bonuses. QR's, RFID's, or active or passive beacons 556 may be scanned at various points in the workflow 500 to track items, provenance, and ownership. In some cases, products may be returned 558 and repaired, reused, refurbished, re-designed, regenerated or the like. Returned or unused garments, as well as scraps and waste, may be transferred 560 to the next use case and regenerated 562 into new textiles, thus reducing waste, minimizing impact on the environment, and enhancing margins. The operating system may track returned waste/remnants and apply credits to the returning factory to encourage recycling/reuse.

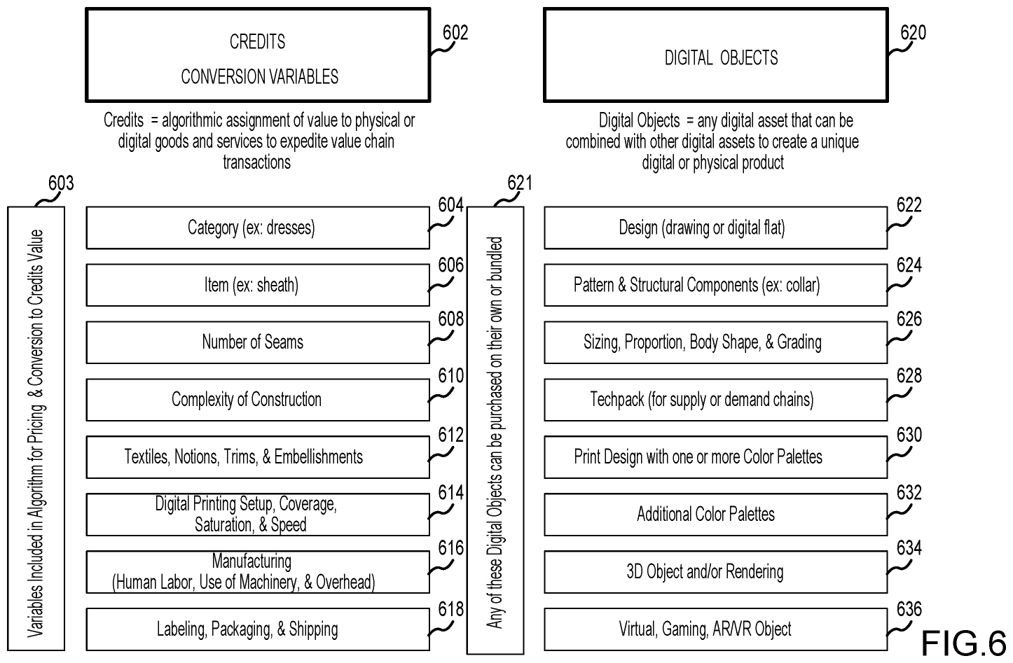

Referring to FIG. 6, the workflow in the fashion industry supply and demand chain, as thus described, involves credits 602 and associated digital objects 620. Generally, credits are a measure of value used in the fashion industry supply and demand chain, for physical or digital goods and services, to expedite transactions, and the value in credits assigned to various functions is determined by an algorithm based on multiple variables 603. Digital objects 620 can be purchased 621 on their own or bundled, e.g., using credits 602 or FIAT monetary value equivalents.

As shown, in the fashion industry example, variables used for pricing and conversion of credits may include any parameter for characterizing goods or services such as category 604; item 606; number of seams 608; complexity of construction 610; textiles, notions, trims, and embellishments 612; digital printing set-up, coverage, saturation, and speed; manufacturing (human labor, use of machinery, and overhead); and labeling, packaging, and shipping. Examples of objects include design (drawing or digital flat); pattern and structural components (e.g., colors or cuffs); sizing, proportion, body shape, and grading; tech pack (for supply and demand chains); print design with one or more color pallets; additional color pallets; 3D object and/or rendering; and virtual, gaming, AR/VR objects.

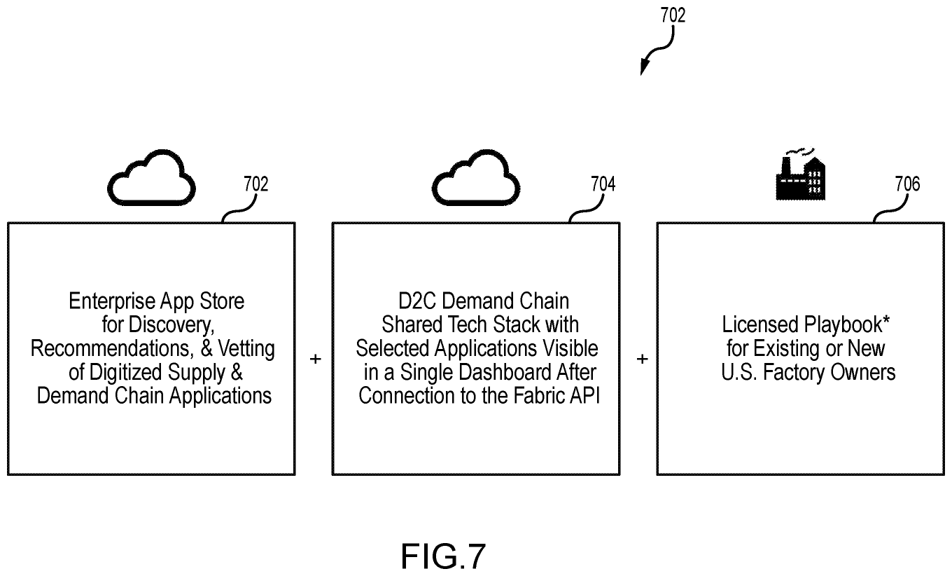

In summary, FIG. 7 shows a high-level overview of the system 700 of the present invention, including microfactory production, as applied to supply and demand chains in the fashion industry. The system 700 may be conceptualized as encompassing three major components; an enterprise app store 702, an integrated direct-to-consumer supply and demand chain 704, and a network of factories 706. The enterprise app store can be used by participants for discovery, recommendations, and vetting of digital technologies, thus facilitating and promoting adoption of digital technologies in the chain. The direct-to-consumer supply and demand chain enables integration of supported digital technologies into a unified techstack with supplementary shared resources such as a single dashboard for tracking workflow and financials. The network 706 of factories enables timely, local, and consistent production of garments by factories having common equipment and/or techstacks. These new or existing factories can license an operations playbook that defines various equipment, management, workflows, training, production parameters and processes including factory design, maintenance, operations, fabrics, colors, dimensions, machine settings, credit values, and the like to ensure timely and consistent production in conformance with brand specifications.

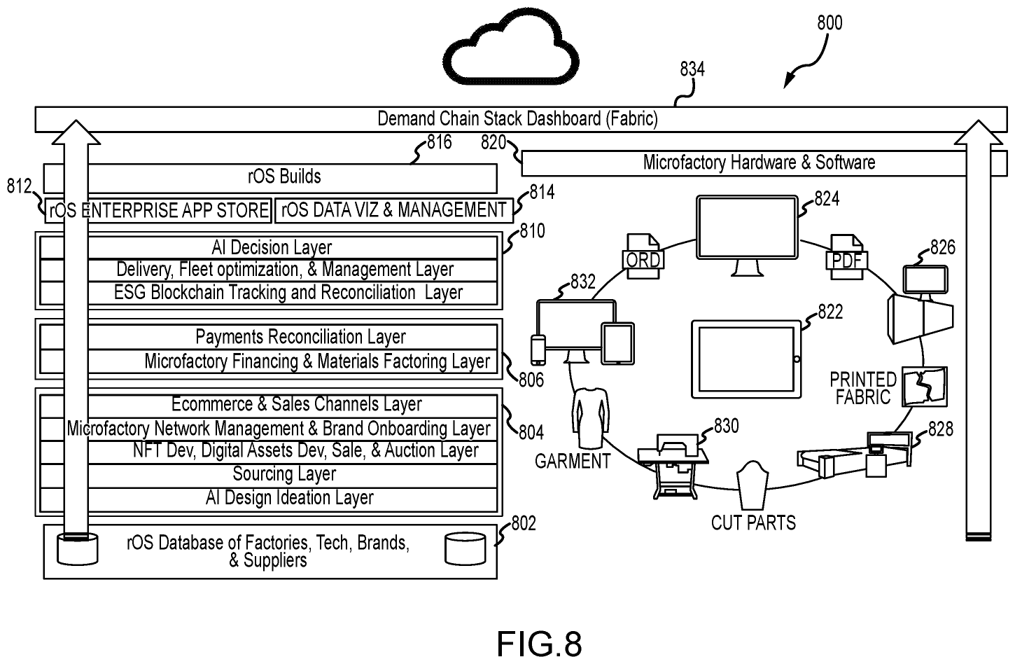

FIG. 8 generally illustrates a system architecture for the inventive system 800, including factory or microfactory production, as applied to a supply and demand chain of the fashion industry. The system 800 may be thought of as an operating system build 816 and a set of factory hardware and software 820, all brought together in the unified system 800 enabling monitoring via a dashboard 834. The operating system build involves an operating system database 802 of factories, digital technologies, brands, and suppliers that are integrated into the operating system and available for individual projects. A production function 804 involves a variety of processes related to design, sourcing, and sales. These may include a design ideation layer, a sourcing layer, product lifecycle management layer, and more. In addition, this function 804 may include a layer for NFT development and digital assets development. Further layers may be implemented for factory network management and brand onboarding as well as e-commerce and sales channels. A financial function 806 may include a payments reconciliation layer and a financing and materials factoring layer. It is anticipated that the system 800 will greatly facilitate access to capital for participating factories, CAPEX for upgrades, or new facilities via possible financing partner integrations. As will be appreciated, integration into the system 800 will provide access to orders from many brands and retail outlets. Consequently, investment in factories will involve significantly less risk than conventional manufacturing and the system may provide access to sources of capital and certification of factories for loan qualification or reduced rates.

The operating system build 816 further includes a distribution and tracking function 810. This may involve a blockchain tracking and reconciliation layer; a delivery, fleet optimization, and management layer; and an AI sequential decision layer for optimizing distribution and management. The build 816 may further involve the enterprise app store 812 for discovery and selection of digital technologies and operating system data visualization and management resources 814.

The right panel of FIG. 8 illustrates an example of a textile manufacturing hardware and software implementation 820. It will be appreciated that the equipment and associated digital technologies are provided to illustrate a microfactory implementation and not by way of limitation. The illustrated microfactory employs a collaboration platform, such as the Yunique® platform of Gerber Technology, for design creation and management. This platform may interface with the external components of the system 800. The collaboration platform 822 may be integrated with CAD design tools, such as Accumark, also provided by Gerber, to develop designs or receive designs/design parameters from a central facility or other operating system digital technology. The CAD design tool 824 may provide a garment design in a compatible format, e.g., PDF, to a controller such as a raster image processor of a direct to fabric printer 826 such as a digital printer and curing equipment. The printer produces printed and cured fabrics that can then be processed using digitally controlled cutting equipment, e.g., provided by Gerber. The cut parts can then be manually or automatically assembled by sewing equipment 830, e.g., of Juki America, Inc., to yield products. The products may be sold (before or after production) and shipped, and payments may be processed, via an e-commerce platform 832 such as Shopify®. These processes may be facilitated and monitored by the dashboard 834.

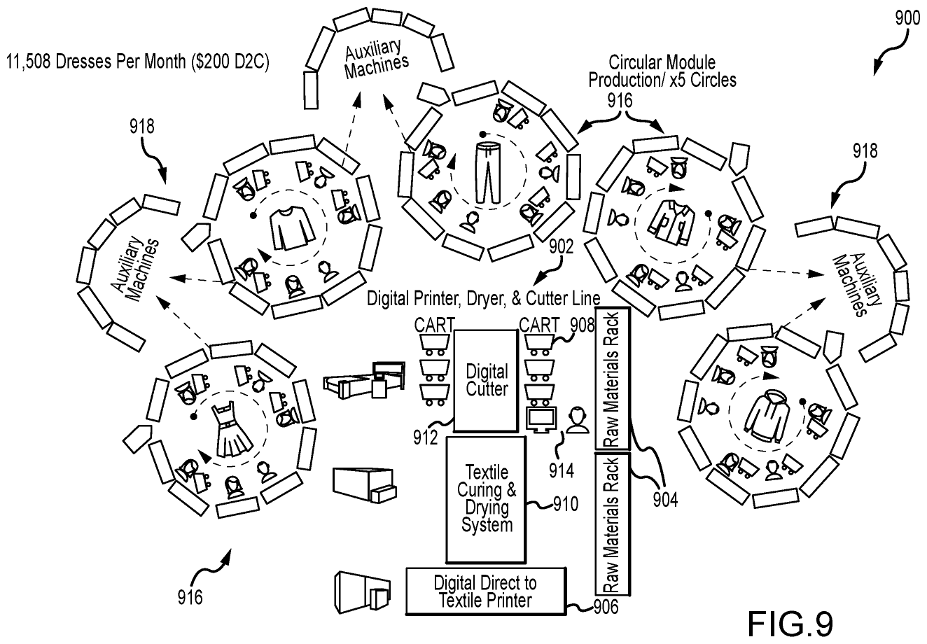

FIG. 9 is a schematic of an exemplary physical design of a microfactory 900. The factory 900 may include a central printing and cutting line 902. In this line 902, raw materials (e.g., fabrics) may be brought from racks 904 to a direct to textile printer 906, e.g., via carts 908 or a conveyor belt/automated retrieval system. After printing, the printed fabric may be processed by a textile curing and drying system 908. The dried fabric may then be processed by a digital cutter 912 to provide cut parts for various garments. The machinery of the line 902 may be operated by one or more human or digital operators 914.

The cut parts may then be delivered (e.g., by cart or automated conveyor) to various assembly pods 916 for assembly of the cut parts into garments. This assembly may involve various auxiliary machines (e.g., sewing and finishing) and workers at various stations in each pod. Several pods may be associated with a packing and shipping service 918 which, again, may include auxiliary machines and workers.

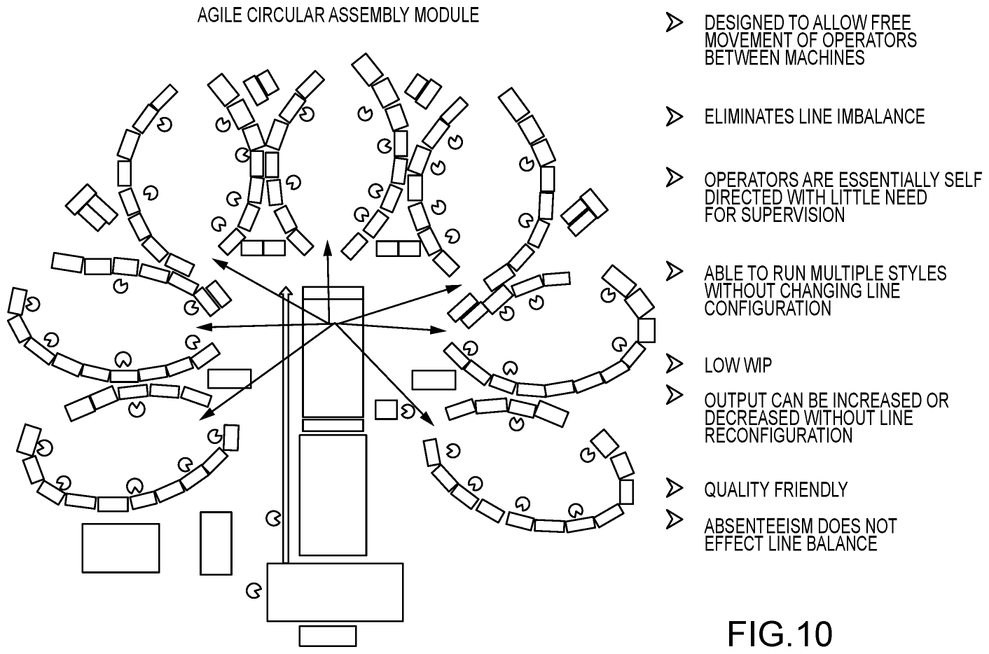

FIG. 10 shows more details of the circular modules or pods 916. The pods are typically oval-shaped or circular and are distributed about the printing and cutting line 902. The line 902 may include an automatic cutting machine or a manual cutting line. Each pod 916 has various entry 920 and exit 922 spaces between some machines 924. This allows operators to access additional work or other machines outside of the pod 916. Typically, machines loaded outside of the pods are for unusual or infrequent operations and can be accessed by multiple pods 916. The pods 916 are designed to allow free movement of operators from one machine 924 to another, moving forward, backward, or across depending on the required machine for the next operation. This enables production of many different styles within a few product categories.

The machine requirements established for these pods 916 ensures that all the machines 924 required to produce the various products are within the pod 916 with an excess of frequently used machines. There may be as much as a 3 to 1 ratio of machines to operators within a pod 916. Preferably, every operator can perform every operation in a standup position. Multiple cells or pods may be needed to make components for more complicated garments such that intermediary products come together in a final assembly pod. A group of several sewing pods may be needed to match the capacity of one printing and cutting line 902.

In operation, operators may attempt to finish the most processed garment first. As operators move from machine to machine, processing their garments, they may encounter an obstacle. For example, this may be a machine in use, an operation that the team has deemed difficult and in need of a more skilled operator, a machine with the wrong color thread, a machine in need of repair, in need of a particular attachment, or an adjustment. In such cases, the operator may leave the garment at a machine and proceed to the next most finished garment that they are able to process. If there are no more garments to process, one can be started in the pod 916 from the line 102 or a predesignated area where cut pieces are stored for production.

Such pods have many advantages over straight-line or traditional systems. They eliminate line imbalance. The pods are self-adjusting and self-balancing so that there is reduced idle time for operators. In addition, operators self-direct within a set of parameters or rules reducing requirements for direct supervision. The resulting movement and self-direction gives operators a sense of empowerment. Moreover, machines do not have to be reconfigured for a style change. Because operators are moving to the machines they need, multiple products with differing operation sequences can run through the line without changing the line layout or configuration so there is no need to move, remove, or add equipment. In addition, there is no need for layout changes when operation sequences change. The output of the system can also be increased or decreased by adding or removing operators without changing the line configuration or adding or removing machines.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A method for use in discovering, integrating, and automating supply and demand chains in the fashion industry, comprising;
establishing a knowledge base of information concerning fashion industry resources including some or all of digital technologies, goods, and services, said digital technologies including digital technologies relating to at least some of textile material science tools, fashion design tools, garment production tools, and e-commerce tools, by compiling a list of said resources and, for each said resource, associating metadata with said resource defining first attributes of said resource; and
operating a processing platform for:
receiving a first user input from a first user concerning one or more subject fashion industry resources;
extracting, from said first user input, one or more second attributes concerning said subject resources;
comparing said first and second attributes to identify one or more matching fashion industry resources; and
providing an output to said first user concerning said matching fashion industry resources.

2. The method of claim 1, wherein said comparing comprises comparing a first supply and demand chain function indicated by said first user input to second supply and demand chain functions of said fashion industry resources.

3. (canceled)

4. The method of claim 1, wherein said comparing comprises identifying at least one digital technology that is compatible with a supply and demand chain operating system.

5. The method of claim 1, wherein said matching resources comprise one of a fashion industry CAD tool, a fashion industry service provider, a material, a direct to fabric printing tool, and a fabric cutting tool.

6. The method of claim 1, wherein said matching resources comprise one of a supply and demand chain operating system, a workflow management tool, and an e-commerce tool.

7-8. (canceled)

9. The method of claim 1, wherein said extracting comprises inferring said second attributes based on analysis of a free-form query.

10. The method of claim 1, wherein said extracting comprises determining said second attributes based on a structure of a user input interface.

11. The method of claim 1, wherein said comparing comprises employing a machine learning engine to identify said matching technologies.

12. The method of claim 1, wherein said output identifies a single matching digital technology.

13. The method of claim 1, wherein said output identifies a stack of multiple matching digital technologies.

14. (canceled)

15-50. (canceled)

51. A system for use in discovering, integrating, and automating supply and demand chains in the fashion industry, comprising;
a knowledge base of information concerning fashion industry resources including resources relating to at least some of digital technologies, goods, and services, said digital technologies relating to at least some of textile material science tools, fashion design tools, garment production tools, and e-commerce tools, said knowledge base including a list of said digital technologies and, for each said digital technology, associated metadata defining first attributes of said digital technology; and
a processing platform operative for:
receiving a first user input from a first user concerning one or more subject resources;
extracting, from said first user input, one or more second attributes concerning said subject resources;
comparing said first and second attributes to identify one or more matching resources; and
providing an output to said first user concerning said matching resources.

52. The system of claim 51, wherein said comparing comprises comparing a first supply and demand chain function indicated by said first user input to second supply and demand chain functions of said fashion industry resources.

53. (canceled)

54. The system of claim 51, wherein said comparing comprises identifying at least one digital technology that is compatible with a supply and demand chain operating system.

55. The system of claim 51, wherein said matching resources comprise one of a fashion industry CAD tool, a direct to fabric printing tool, and a fabric cutting tool.

56. The system of claim 51, wherein said matching resources comprise one of a supply and demand chain operating system, a workflow management tool, and an e-commerce tool.

57-58. (canceled)

59. The system of claim 51, wherein said extracting comprises inferring said second attributes based on analysis of a free-form query.

60. The system of claim 51, wherein said extracting comprises determining said second attributes based on a structure of a user input interface.

61. The system of claim 51, wherein said comparing comprises employing a machine learning engine to identify said matching technologies.

62. The system of claim 51, wherein said output identifies a single matching digital technology.

63. The system of claim 51, wherein said output identifies a stack of multiple matching digital technologies.

64-100. (canceled)
